(19) United States
(12) Patent Application Publication
(10) Pub. No.: US 2007/0183033 A1
(43) Pub. Date: Aug. 9, 2007

(54) Multi-lens lenticular system and lighting device for an autostereoscopic display

(75) Inventor: Armin Schwerdtner, Dresden (DE)

Correspondence Address: SYNNESTVEDT LECHNER & WOODBRIDGE LLP, P O BOX 592, 112 NASSAU STREET, PRINCETON, NJ, 08542-0592, US

(73) Assignee: SEEREAL TECHNOLOGIES GMBH, Dresden (DE)

(21) Appl. No.: 11/571,694

(22) PCT Filed: Feb. 9, 2005
(86) PCT No.: PCT/DE05/00251

§ 371 Date: Jan. 5, 2007

(30) Foreign Application Priority Data
Aug. 19, 2004 (DE) 10 2004 040 086.5
Jul. 9, 2004 (DE) 10 2004 034 782.4

(51) Int. Cl. G02B 27/22

(52) U.S. Cl. 359/463

(57) ABSTRACT

The invention relates to a multi-lens lenticular system and a lighting device for an autostereoscopic display. Said display comprises, in the direction of light, an illuminating matrix (7), a focusing matrix (8), and a transmissive data panel (5). The illuminating matrix is provided with a plurality of light-penetrated controllable openings (21). The focusing matrix (8) focuses the light of said openings (21) in such a way that the data panel (5) and a preferred visible zone (6) are illuminated in a directed manner while being composed of a multi-lens lenticular system (LM) whose lenticles (L) are structured into several subordinate lenticles (S1, S2, . . . ). The subordinate lenticles are arranged such that a multiple number of images having an associated enlarged brightness distribution (V) ranging from (A) to (C′) is created in the visible zone (6) by the light of an opening (21) while the resulting images of laterally adjoining openings (21) overlap in the edge regions thereof, thus creating a nearly homogeneous brightness distribution (V). The homogeneous brightness visibly increases the quality of the image for the viewer.

### FIELD OF THE INVENTION

The invention relates to an arrangement of lenticular lenses, particularly for autostereoscopic displays. The invention relates to lenticular arrays with parallel lenticles in particular as described by the group of lenticular arrays with cylindrical lenses.

The multi-lens lenticular array, for example, is usable in an illumination device for autostereoscopic displays with a non-luminous transmissive information panel for the representation of two-dimensional and three-dimensional information with high image quality.

For autostereoscopic displays it is necessary to spatially separate the right and left views of the image information by means of an optical projection system. In order to make it possible to view image information stereoscopically, the left/right image content provided for the left/right eyes of the viewer must be supplied to the left/right eyes with as little cross-talk to the respective other eye as possible.

The means for meeting this demand is also known as an image separating device and is realized, for example, by an illumination matrix and a focusing matrix. These and other major elements of autostereoscopic displays are realized by lenticular arrays, or combined with lenticular arrays, respectively, so that lenticular arrays are very important components.

### PRIOR ART

For autostereoscopic displays, lenticular arrays are often mentioned in the literature and in a multiplicity of inventions. As a rule, lenticular arrays are used with single spherical lenticles, that is lenticles being at least approximately circular.

U.S. Pat. No. 1,922,932, of 1930, describes a transparent material that is applied to a window pane to produce a “one-way vision window”. The lenses, which are similar to a lenticular array, should have a width at least equal to the diameter of the eye pupil in order to be able to be looked through. This arrangement consists of horizontal concave or convex lenticles and prisms. Therefore a viewer whose eyes are near to the non-curved surface can look through the material, whereas the scene behind it is distorted for a more distant viewer.

U.S. Pat. No. 3,740,119 A shows lenticular films with the aim of multiplying the images and targeted focusing in a projection apparatus, whereby on said films the known spherical or cylindrical lens shape of the lenticles is reproduced by polygonal curves symmetrical about the center line. The achieved prism surfaces bordering each other produce, depending upon the prism angle, several projections shifted by a distance. Equidistant images can be produced by equidistant prism angles.

WO 99/23513 A1 discloses a transparent film as a double lenticular array that has on either side a lenticular arrangement the lenses of which have different radii, their optical axes being laterally shifted with respect to each other in order to focus in a 3D-display such that a greater depth of field is given.

JP 2002-031854 A discloses an arrangement of convex lenticular lenses on the front and rear sides of a double lenticular array for a rear projection display. The lenticular array, being the second in the direction of transmission, is configured in the form of three lenses, that is a central lens and two lenses symmetrical with respect to the central lens, whereby each sublenticle is aligned with the accompanying subpixel of the three subpixels RGB in a color display. This arrangement is intended to produce a parallel exit of the respective rays from each subpixel. In this way better effectiveness of light transmission and better color representation should be achieved.

DE 19822342 A1 discloses a design of the lenticular array in which the lenticles are designed to have the same size as the subpixels, which are arranged in groups each in the form of prisms.

In the following, prior art of an illumination device for an autostereoscopic display with a non-luminous transmissive information panel will be considered. Such a display comprises an illumination matrix as the first unit in the direction of propagation of the light. In this document, the concept of the illumination matrix is meant to be the generic term for a matrix with a plurality of controllable light sources or a matrix with a plurality of controllable openings illuminated in transmission. The illumination matrix is, as a rule, implemented to be non-luminous but consists, for example, of a backlight as the light source and a shutter with a plurality of matrix-like arranged openings for the control of light transmission.

In this document, the optical unit arranged between the shutter and the transmissive information panel is designated as the focusing matrix. In the following illustration of the state-of-the-art, reference is made to this nomenclature.

The focusing matrix focuses the light exiting from the openings of the shutter such that the subsequent transmissive information panel and a selectable preferred region of visibility in the viewer plane are directionally illuminated. Various, extensive requirements are therefore established for the focusing matrix, as said matrix has an essential influence on the properties of the image in the viewer plane. The matrix has significant responsibility for the image quality perceived by the viewer, such as the distribution of brightness.

Aside from other factors, the distribution of the brightness within the image depends upon whether the discrete light sources represented by the openings of the shutter can successfully be transferred into a brightness distribution which is homogeneous over the viewer plane.

For autostereoscopic displays a plurality of versions of the illumination matrix and the focusing matrix are known. As a rule, lenticular arrays with simple, convex-spherical lenses are used for the focusing matrix, but a plurality of embodiments of the focusing matrix are known as described in the following.

A fundamental embodiment of an autostereoscopic display is described in WO9423340 A1 or EP0691000 B1, of the applicant.

Described is an optical system for the two-dimensional and three-dimensional representation of information using a transmission display which is divided for each viewer into accompanying stereo images, at least one point or line light source being provided, which, when seen from the viewer or viewers position, is located behind the transmission display, and further a collimation and a focusing optical system. A prism of a prism mask and a phase element of a phase mask with random optical phase-distribution are assigned to each pixel of the transmission display, whereby the light corresponding to the stereo images is bent and focused on to the eyes of the viewer or viewers.

Another embodiment of an autostereoscopic display is described in DE 10359403 A1 of the applicant. It discloses an autostereoscopic multi-user display with a sweet-spot unit. The display consists of an illumination matrix and a projecting matrix with a field lens; therefore the focusing matrix here consists of the projecting matrix and a field lens. The projecting matrix has the function to project the switched-on elements of the illumination matrix in appropriate directions into the space before the display so that the subsequent field lens focuses them as sweet-spots on the eyes of the viewer. The projecting matrix is designed as a tandem lenticular array including two parallel, equally directed single lenticular arrays. Another version of the projecting matrix provides the use of a double lenticular array. The field lens is configured as a Fresnel lens or as a holographic optical element.

EP0788008 B1 and EP0827350 A3 also describe an arrangement for an autostereoscopic display. In EP 0788088 B 1 the display comprises a light source for the radiation of light out of a plurality of openings and an array of optical elements with various optical functions in the horizontal and vertical directions to direct the light of the openings through a transmissive display.

The array of optical elements—in this case, the focusing matrix—consists of a row of cylindrical lenses arranged horizontally next to each other and aligned to be vertical, each of which consists of a planar surface and a convex surface (a semi cylinder).

EP 0827350 A3 discloses an autostereoscopic display. It consists of a light source for illumination, a planar illuminant, and a carrier mask with a chessboard-like arrangement of openings and further a vertical cylindrical lens array—the focusing matrix in this case—consisting of vertical cylindrical lenses (semi cylinders) and a transmissive display. Similar to the last-mentioned document the lens array functions to direct the light of the openings through the transmissive display.

EP0881844 B4 describes another arrangement of an autostereoscopic display; here the focusing matrix comprises a first lenticular mask with horizontal semi cylinder-shaped lenticles, a diffuser and another lenticular mask with horizontal semi cylinder-shaped lenticles.

EP1045596 A2 discloses another optical system as the focusing matrix; in this case the matrix consists of an array of vertically arranged cylindrical lenses followed by, in the direction of light propagation, an array of horizontally arranged cylindrical lenses. The lenses of the lens arrays each are aligned at a distance matching the pattern of the openings of the shutter.

JP7234459 describes a lenticular array comprising a plurality of lenticles located parallel to the stripes of vertical openings of a shutter. The lenticles of this focusing matrix, the aperture of which is equal to the stripe distance, are designed to be semi cylindrical.

DE 297 10 551 U1 describes an autostereoscopic arrangement for the three-dimensional representation of information using a color display. In front of the color display a laterally slidable prism mask is placed and is provided with one prism wedge per image column, whereby each prism wedge is equivalent to the width of the image columns and the prism angle is chosen such that the left columns of the display are seen by the left eye and the right columns are seen by the right eye.

An essential requirement of the illumination matrix and, particularly, of the focusing matrix is that the information panel and the preferred region of visibility are illuminated as homogeneously as possible in the viewer plane; in the above-mentioned documents this is not realized in a desirable manner.

The alignment of the bundles of rays of single lenticles to form completely illuminated areas in the viewer or projection plane is not presented or described in great detail in the documents, although this considerably influences the quality of the visible image within the projection.

Considering the separated discrete light sources—due to the openings of the shutter—with shaded interstices, the bundles of rays are not sufficiently aligned with respect to each other. In particular, the images of the interstices produce transitions with low luminance in the preferred region of visibility, which hence are perceivable by the viewer as unwanted narrow dark lines—zones of low luminance. This leads to the disadvantage of a recognizably worse image quality.

For a homogeneous illumination of the region of visibility it is necessary to superimpose the images of the openings in the region of visibility, that is to blur and/or distort the image of an opening and the associated ray paths. This superimposition is not reached, or cannot be reached, to a sufficient extent by the cylindrical, semi cylindrical, or spherical lenticles in the above-mentioned solutions.

To superimpose the paths of rays, an aspheric lenticle, or even an asymmetric aspheric lenticle, would be required; these types of lenticles as part of the focusing matrix are not included in the above-mentioned documents so that recognizably worse image quality with respect to a homogeneous luminance distribution can occur.

Further it is necessary, particularly with autostereoscopic displays, to avoid, or reduce, all known side effects of the optical system such as aberrations, moire, coma, and the like, including pseudoscopic or inhomogeneous luminance distribution. In addition, it is necessary to create a stereoscopic vision region as wide and as homogeneous as possible free of cross-talk—the sweet-spot. With cross-talk, or pseudoscopy, the right eye sees image portions that are meant for the left eye, and vice versa. Cross-talking results in pseudoscopic images which differ from the intended stereoscopic images by inverted depth of field.

In order to eliminate or at least reduce the above-mentioned optical side effects, also here an aspheric lenticle, or even an asymmetric aspheric lenticle would be required.

These types of lenticles as part of an autostereoscopic display, however, are not included in the documents mentioned above as prior art so that a recognizably worse image quality, for example with respect to a homogeneous luminance distribution, image separation, and a cross-talk-free sweet-spot region or the like can occur.

Aspheric and/or asymmetric lenticles, however, are disadvantageous in that they are difficult to manufacture and, as a rule, can be produced only at a very high expense, particularly when seen from the miniaturization point of view. In order to reach these goals, often the lens dimension, i.e. the pitch of the lenticles, is coupled to the pitch of an image matrix. The term “image matrix” is used here as the generic term for self-luminous or transmissive displays.

If only one pixel column of the image matrix, for example, is allocated to a lenticle of the lenticular array, several serious problems result as the pixel dimensions of the image matrix continuously decrease. With further reduction in size of the pixels as the reference dimension, the danger arises that the bounds of optical feasibility would be reached, at least with regard to cost-effective and process-reliable manufacture of the lenticular arrays.

Also, if a lenticle contains spherical cylindrical lenses and is assigned to a few pixel columns only, the limits of a process-reliable manufacture of the lenticular arrays with this shape are soon reached. Economic and process-reliable manufacture generally appears to be problematic. Compared with spherical lenticles, the production effort further rises for asymmetric and/or aspheric lenticles.

While keeping the above-mentioned tasks in mind—reduction of the optical side effects—a lenticular array should be created that features the advantageous optical properties of an aspheric and/or asymmetric lenticle, and which can be simply designed, as required by manufacture and adjustment, and produced at low cost and reliably, also under the aspects of miniaturization.

### SUMMARY OF THE INVENTION

A multi-lens lenticular array, particularly for autostereoscopic displays, consists of a plurality of lenticles adjacent to each other and arranged in parallel. A central axis, which divides the aperture of the lenticle, is assigned to each lenticle.

The invention is based on an idea to discretely approximate an individual aspheric and/or asymmetric lenticle by a lenticle that is structured as a number of simply shaped sublenticles. To achieve this, the lenticle is divided into a number of individual sublenticles, which are further defined by their centers and radii of curvature.

According to the invention one or several sublenticles are arranged in the axial direction, i. e. in the direction of the central axis of the lenticle, and/or in a lateral direction offset from the central axis of the lenticle. The lateral direction is defined by the reference vector lying in the plane of the lenticular array orthogonal to the parallel lenticles.

In terms of the approximation to an individual aspheric and/or asymmetric lenticle, the division of the lenticle into sublenticles and their alignment, namely the location of their centers and their respective radii of curvature, can be varied. To achieve this, the sublenticles preferably are described by convex spherical lens segments.

A further preferred embodiment provides that a sublenticle or several sublenticles are aligned such that the optical axis of each sublenticle is inclined to the central axis of the lenticle.

The sublenticles on the margins of the lenticle, for example, have an inclined optical axis, whereby, in particular, these sublenticles can be offset in the axial direction of the central axis of the lenticle.

The invention is based on the idea that a sublenticle, whose optical axis is inclined relative to the central axis of the lenticular array, can be interpreted as an implicit combination of a spherical lens and a wedge term. Utilizing this idea of the invention, particularly the above-mentioned preferred embodiment with the inclined sublenticles, i. e. the inclined wedge terms, can reduce many disturbing side effects of the optical system.

Generalizing, said embodiment of the invention can reduce the effect of light being directed along incorrect paths. For example, in autostereoscopic displays those bundles of rays that run through the margin of the lenticle result in aberrations in which light is bent to a region not visible to the viewer.

In another embodiment, several sublenticles within a lenticle are arranged symmetrically around a sublenticle centered on the central axis of the lenticle. Preferably, the centered sublenticle is relatively large and covers nearly the entire aperture of the lenticle, whereby the sublenticles, preferably inclined, arranged at the margins of the lenticle can serve, for example, to lessen the side effects of the aberrations.

In another embodiment, the aperture of the lenticles of the lenticular array is variable and is, for example, a linear function of the distance of the lenticle from the central mid-axis of the lenticular array. Such a functional connection, for example, is given by the distance of the lenticle from the viewer.

Further embodiments concern the transition of the sublenticles within a lenticle or the transition of neighboring sublenticles. As to details of the definitions and embodiments, see FIG. 3 which follows.

Another embodiment of the invention is described by an illumination device for an autostereoscopic display. Such an exemplary display consists, in the direction of light propagation, of an illumination matrix, a focusing matrix, and a subsequent transmissive information display. In detail, the illumination matrix includes, given in the direction of light propagation, an illumination matrix and a focusing matrix. The illumination matrix consists of a plurality of matrix-like arranged controllable openings illuminated in transmission, or of self-luminous light sources. As a rule, the illumination matrix consists of a backlight as the light source and a shutter with controllable openings for controlled illumination in transmission. With its intermediate spaces of lower illumination in transmission, which are caused by design, the shutter has a plurality of matrix-like arranged openings.

The subsequent focusing matrix consists of a lenticular array with a plurality of lenticles bordering each other which are each aligned parallel to the columns or lines of the openings of the shutter.

The focusing matrix is followed by a transmissive information panel.

The matrix focuses the light from the openings in the shutter such that the information panel and a selectable preferred region of visibility in the viewer plane are illuminated directly. p According to the invention the focusing matrix consists of a multi-lens lenticular array, the lenticles of which each are divided into sublenticles. According to the invention the sublenticles are arranged and aligned such that they produce in the region of visibility a multiple number of images of the openings, corresponding to the number of sublenticles, in such a way that a nearly homogeneous luminance distribution in the region of visibility results.

For an arrangement according to the invention, a number of accompanying images multiplied in correspondence with the number of sublenticles occur in the preferred region of visibility after opening the shutter. Said images are each characterized by the appropriate accompanying trapezoid-shaped luminance distribution. Said luminance distributions are offset from each other in an overlapping manner. According to the invention the laterally offset trapezoids, while overlapping, lead to a broadened resulting luminance. The resulting luminance of an opening therefore is clearly broadened so that the images of several openings originating from a lenticle overlap.

In the region of visibility, the laterally adjacent openings produce the mentioned broadened trapezoid-shaped luminance distributions. With the arrangement according to the invention the marginal regions thereof are overlapping.

Each of the mentioned trapezoid-shaped luminance distributions consists of a rectangular ideal distribution of the bundle of rays and of sloping margins, which are caused by the real optical properties of the sublenticles arising from the “point spread function”.

Due to their inventive arrangement and alignment, said margins of the luminance values in the region of visibility overlap, whereby according to the idea of the invention, working backwards from the required luminance overlappings—from each opening and laterally adjacent openings—as well as from the defined geometry of these openings and considering the point spread function, the arrangement of sublenticles and in particular the alignment of sublenticles—especially the inclination of the optical axis of each sublenticle—are determined.

With the substantially maximum overlapping of these margins of the images of the openings, a nearly homogeneous resulting distribution of the luminance is created at these transition regions. This results in a nearly homogeneous illumination in the region of visibility and on the display.

The darker regions between the images of the openings are almost eliminated, and the quality of the image representation is enhanced noticeably for the viewer.

With a further division of the lenticles in terms of approximating an aspheric lenticle the resulting luminance distribution is substantially improved. This approximation is also valid for an asymmetric lenticle, whereby particularly in this case the arrangement and inclination of the sublenticles can differ. Simpler embodiments of the multi-lens lenticular array have symmetries such as equal angles of inclination and/or a symmetric arrangement of the sublenticles.

Preferably, a central, large sublenticle is arranged in the region of the central axis of the lenticle and hence in the region of small aberrations.

The multi-lens lenticular array according to the invention is also advantageous in known designs of double lenticular arrays with vertices in the same or in opposite directions and is also usable in crossed lenticular arrays. The integration of a field lens into a multi-lens lenticular array is also conceivable.

An autostereoscopic display with one or more multi-lens lenticular arrays according to the invention is characterized by its usability in 2D- and/or 3D-mode, its multi-user suitability, its enablement of free mobility of the viewer, its high resolution, its great brightness and its small depth. Thanks to its high quality features as regards image representation and low cross-talk, it is well suited for high-end applications in the fields of medicine, technology, research and development, for mid-range applications in video-conference systems and administration, in financial institutions, and in insurance companies, and for low-end applications, e.g. home displays, videophones and many other applications.

### SHORT DESCRIPTION OF FIGURES

The following figures illustrate examples of embodiments of the multi-lens lenticular array according to this invention, and an illumination device according to the invention, as components of an autostereoscopic display.

The figures relate to a lenticle of the multi-lens lenticular array and what is shown is:

FIG. 1a to 1c a multi-lens lenticular array of this invention which is divided into three sublenticles with parallel optical axes;

FIG. 2 a multi-lens lenticular array of this invention is divided into three sublenticles, whereby the optical axes of the sublenticles arranged at the margins are inclined towards the central axis;

FIG. 3 a schematic view of transitions between neighboring sublenticles;

FIG. 4a a schematic view of the arrangement of sublenticles which approximate an aspheric lenticle segment;

FIG. 4b a schematic view of the arrangement of sublenticles which approximate an aspheric and an asymmetric lenticle segment;

FIG. 5 a schematic view of the distribution of the bundles of rays of an illumination device for an autostereoscopic display with a multi-lens lenticular array of this invention;

FIG. 6 a representation of the distribution of the bundles of rays which expands on FIG. 5 in greater detail.

### PREFERRED EMBODIMENTS

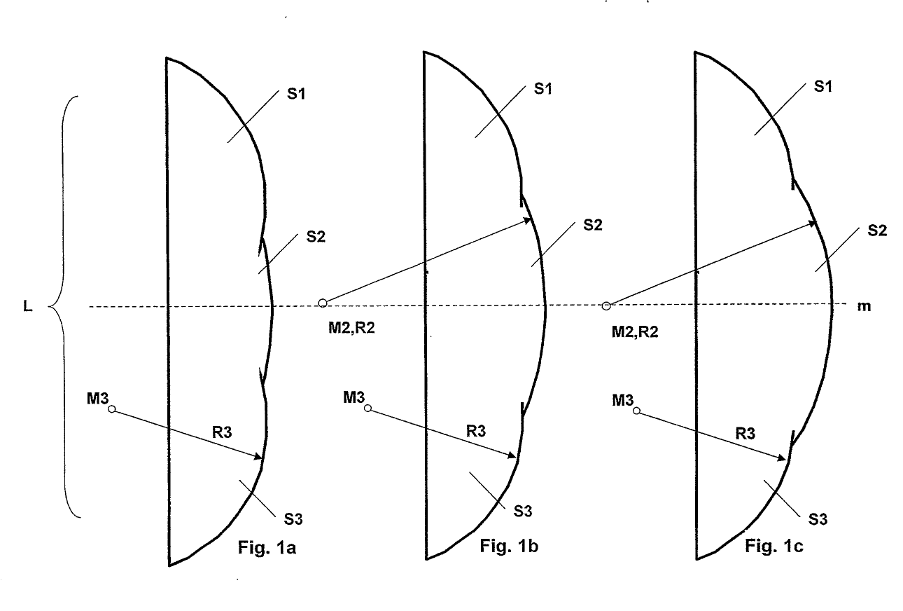

FIG. 1a shows a first embodiment of the multi-lens lenticular array. Here a lenticle L is divided into three sublenticles S1 to S3. In the center of the central axis m of the lenticle L there is a large central sublenticle S2, and two other smaller sublenticles S1, S3 border on it and are arranged at the margins. The sublenticles S1 to S3 together cover the aperture of the lenticle L. The optical axes of the sublenticles are aligned parallel to the central axis m of the lenticle.

When compared with FIG. 1a, the embodiment of FIG. 1b shows the same sublenticles. But the sublenticles S1 and S3 arranged at the margin are shifted in the axial direction of the central axis m. With the same radii of curvature R1 and R3 as in FIG. 1a, the centers of curvature M1 and M3 each are shifted in the axial direction of the central axis, m, i. e. in the direction of propagation of the light.

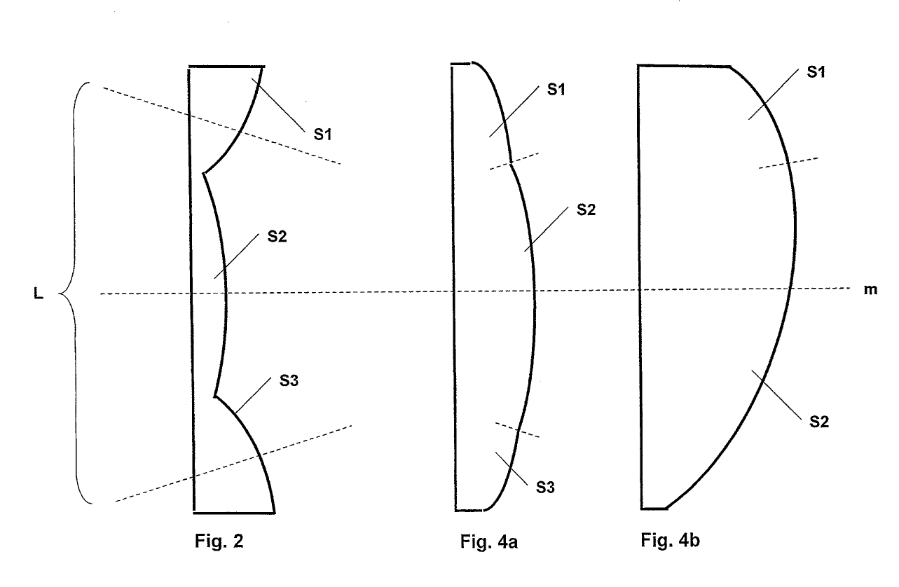

For comparison, the sublenticles S1 and S3 in FIG. 1c are arranged offset in opposite directions. FIG. 2 shows a lenticle divided similarly to FIG. 1. The sublenticles S1 and S3 arranged at the margins, however, have an optical axis inclined relative to the central axis m. Such an embodiment is preferred as the inclined sublenticles S1 and S3 implicitly include an optical wedge term. The path of rays through the margins of the lenticle can be advantageously influenced by the inclined sublenticles.

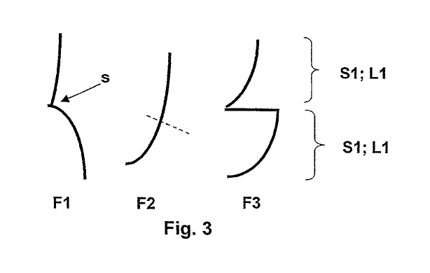

FIG. 3 shows a schematic view of transitions between neighboring sublenticles. A first transition shape F1 shown on the left of FIG. 3 is coherent with the edge, whereby the sublenticles have a line of intersection, s, in common. Another transition shape F2 is coherent without an edge, whereby the sublenticles have a tangential plane in common so that here a sublenticle without an edge passes into a neighboring sublenticle. As shown in the figure, the transition shape F3 is discontinuous, i. e. interrupted.

The transition between two neighboring lenticles is similar.

FIG. 4a shows an embodiment of sublenticles which approximates an aspheric lenticle. There is a central sublenticle S2 and two sublenticles S1 and S3 offset from the central axis m towards the edges. Here the sublenticles S1 to S3 have about the same radius. By combining the sublenticles S1 to S3 an aspheric lenticle is approximated.

FIG. 4b shows an embodiment of a coherent transition of sublenticles without an edge. Here a central sublenticle S2 has an inclined optical axis. The region shown on top of the drawing of this sublenticle S2 passes coherently without an edge into the smaller sublenticle S1. By combining the sublenticles S1 and S2, an aspheric lenticle is approximated.

In the following, the multi-lens lenticular array according to the invention is explained for an autostereoscopic display in particular. In a first part the display in the direction of light propagation consists of an illumination matrix 7 with a plurality of controllable, openings illuminated in transmission.

The illumination matrix 7 here is exemplarily realized as being non-luminous, but consists of the backlight 1 as the light source and a shutter 2 having a plurality of openings 21 disposed in a matrix-like arrangement for controlled illumination in transmission.

A focusing matrix 8 follows, which consists of a lenticular array LM with a plurality of lenticles L bordering each other which are each aligned parallel to the columns or rows of the openings 21 of the shutter 2.

By means of the matrix 8 the light of these openings 21 is focused such that a subsequent transmissive information panel 5 and a selectable preferred region of visibility 6 are directly illuminated in the viewer plane 9.

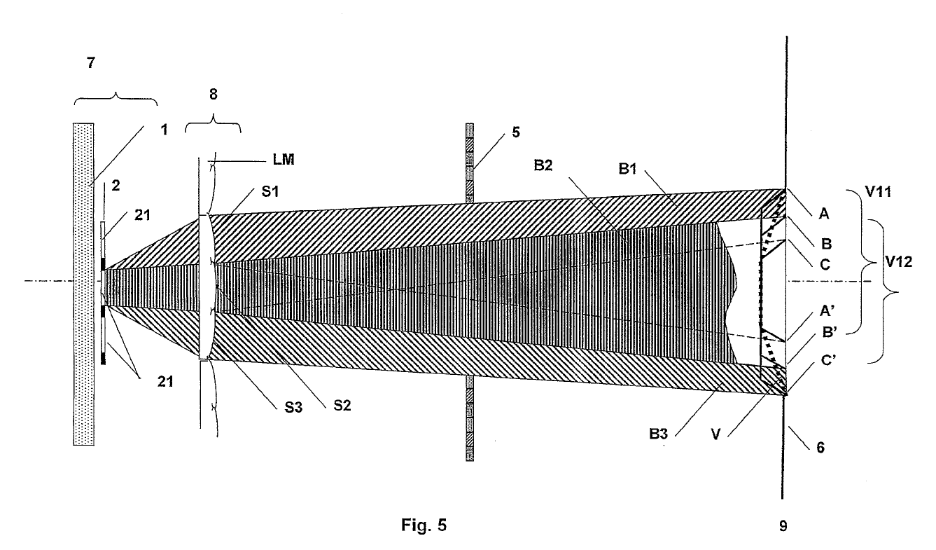

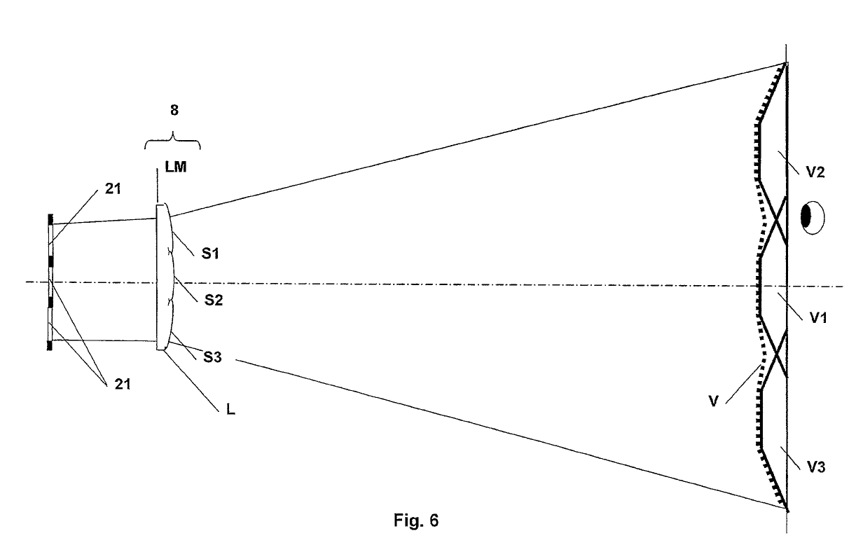

FIG. 5 shows a section of the illumination matrix with a multi-lens lenticular array LM and a schematic representation of the distribution of the bundles of rays for an opening 21 of the shutter 2.

The matrix 8 according to the invention consists of a multi-lens lenticular array, the lenticles L of which are divided into several sublenticles S1, S2, . . . .

In this schematic embodiment, the sublenticles describe a simple form of the discrete approximation to an aspheric lenticle considered individually. Here a given lenticle L of the multi-lens lenticular array LM is divided into three sublenticles S1 to S3. A sublenticle S2 is in the center of the optical axis m of the lenticle L. Two other sublenticles S1 and S3 are arranged symmetrically with respect to the sublenticle S2. The sublenticles S1 to S3 cover the aperture of the lenticle L and divide it into three intervals of equal length. The multi-lens lenticular array LM is planar on its light entry side. The optical axes of the sublenticles S1 and S3 being at the margins, each is inclined relative to the central axis m of the lenticle L.

The vertically hatched area shows exemplarily the distribution of the bundle of rays B2 from the central opening 21 of the shutter 2 passing through the central sublenticle S2 up into the viewer plane 9.

With the basic points of the trapezoid B-B′ the accompanying distribution of the luminance V12 in the region of visibility 6 in the viewer plane 9 is represented. This trapezoid-shaped distribution consists of the rectangle of the ideal distribution of the bundle of rays as well as of blurred marginal regions. Said marginal regions are caused by the real optical properties of the sublenticles and can be described through the “point spread function”.

The superimposed bundles of rays B1 and B3 of the sublenticles S1 and S3 are represented at the margins by the diagonally hatched areas. The bundle of rays B1 runs through the sublenticle S1 (shown on top in the drawing) and provides in the viewer plane 9 the accompanying course of the luminance distribution V11; the trapezoid of the luminance distribution V11 is marked with the basic points A-A′. By analogy the basic points C-C′ identify the trapezoid of the luminance V13 which results from the bundle of rays B3 for the sublenticle S3 arranged on the bottom of the drawing.

The superimposition of the luminances V11 to V13 results in the luminance distribution V shown by a dashed line. Thanks to the generated multiplication of the number of images, which according to the invention is equal to the number of sublenticles (here S1+S2+S3=3), and the laterally overlapping shift of the images, a broadened homogeneous region of the resulting luminance distribution V is created. The resulting region of the luminance V runs with its sloping marginal regions between the basic points A and C′, and is correspondingly broadened.

Analogously to FIG. 5, FIG. 6 shows a device according to the invention; a schematic representation is shown of the distribution of the bundles of rays from three openings 21 of the shutter 2 through the multi-lens lenticular array LM up to the images of the openings 21 in the preferred region of visibility 6 of the viewer plane 9.

With respect to the preferred region of visibility, these three openings 21 originate from the same lenticle L.

In the region of visibility 6 the images of the three openings 21 create the courses V1 to V3 of the broadened luminances previously explained in FIG. 1, resulting from V11 to V13 respectively. According to the invention, the division of a given lenticle L into sublenticles and the arrangement and alignment of the sublenticles S1, S2, . . . causes the overlapping sloping marginal regions of the luminance V1 to V3.

The paths of the bundles of rays from the sublenticles S1 to S2 arranged according to the invention are directed such that the sloping marginal regions of the images V1 to V3 of the three openings 21 superimpose. The dashed line shows the course V of the luminance resulting from the superimposition of V1 to V3.

The resulting distribution of the luminance V is therefore characterized by only a very small fall off in the luminance V in the region of the superimposed marginal regions. Thus according to the task of the invention, a nearly homogeneous resulting distribution V of the luminance develops in the entire preferred region of visibility 6.

With the substantially maximum superimposition of these marginal regions of the images of the openings, a nearly homogeneous resulting distribution of the luminance develops in these transition regions. Thus in the region of visibility as well as on the display a nearly homogeneous illumination results. Darker regions between the images of the openings are substantially eliminated and the quality of the image representation is visibly enhanced for the viewer.

### REFERENCE LIST

| | |
|---|---|
| LM | multi-lens lenticular array |
| L | lenticle of the lenticular array |
| m | central axis of the aperture of the lenticle |
| S1, S2, . . . | sublenticle of the lenticle |
| SZ | centrally arranged sublenticle |
| 1 | backlight |
| 2 | shutter; with |
| 21 | openings |
| 5 | transmissive information panel |
| 6 | preferred region of visibility |
| 7 | illuminating matrix |
| 8 | focusing matrix |
| 9 | viewer plane |
| B1 to B3 | distribution of the bundle of rays from an opening |
| A-A′ to C-C′ | basic points of the trapezoid of the luminance in the |
| | viewer plane for the bundle of rays B1 to B3 |
| V11 to V13 | distribution of the luminance through one opening |
| V1 to V3 | distribution of the luminance through three openings |
| V | resulting distribution of the luminance |

1. Multi-lens lenticular array, particularly for autostereoscopic displays, with a plurality of lenticles (L) bordering each other and arranged in parallel, whereby to said lenticles (L) a central axis (m) which divides the aperture of the lenticle (L) is assigned, characterized in that each lenticle (L) is structured as several connected sublenticles (S1, S2, . . . ), whereby all sublenticles (S1, S2, . . . ) together cover the aperture of the lenticle (L), and one or several sublenticles (S1, S2, . . . ) are arranged offset in the axial direction of the central axis (m) of the lenticle (L) and/or in a lateral direction of the central axis (m) of the lenticle (L).

2. Multi-lens lenticular array of claim 1 characterized in that the sublenticles (S1, S2, . . . ) are described by convex spherical lens segments.

3. Multi-lens lenticular array of claim 1 characterized in that one or several sublenticles (S1, S2, . . . ) are aligned such that the optical axis thereof in each case is inclined to the central axis (m) of the lenticle (L).

4. Multi-lens lenticular array of claim 3 characterized in that neighboring lenticles (L) have a coherent transition at the adjacent sublenticles (S1, S2) with a common line of intersection (s).

5. Multi-lens lenticular array of claim 4 characterized in that neighboring lenticles (L) have a coherent transition, without an edge, at the adjacent sublenticles (S1, S2) with a tangential plane in common

6. Multi-lens lenticular array of claim 1 characterized in that neighboring lenticles (L) have a discontinuous transition at the adjacent sublenticles (S1, S2).

7. Multi-lens lenticular array of claim 1 characterized in that neighboring sublenticles (S1, S2) of a lenticle (L) have a coherent transition with or without an edge.

8. Multi-lens lenticular array of claim 1 characterized in that in a lenticle (L) several sublenticles (S1, S2, . . . ) are arranged symmetrically around a sublenticle which is centered on the central axis (m) of the lenticle (L).

9. Multi-lens lenticular array of claim 1 characterized in that in a lenticle (L) all sublenticles (S1, S2, . . . ) are arranged symmetrically around the central axis (m) of the lenticle (L) without a sublenticle being arranged centrally.

10. Multi-lens lenticular array of claim 1 characterized in that the sublenticles (S1, S2, . . . ) of the lenticle (L) have different radii of curvature (R1, R2, . . . ) and/or centers (M1, M2, . . . ).

11. Multi-lens lenticular array of claim 1 characterized in that the sublenticles (S1, S2, . . . ) of a lenticle (L) have equal aperture sizes.

12. Multi-lens lenticular array of claim 1 characterized in that one or several sublenticles (S1, S2, . . . ) describe aspheric and/or asymmetric lens segments.

13. Multi-lens lenticular array of claim 1 characterized in that the lenticles (L) of the lenticular array have a variable aperture size.

14. Multi-lens lenticular array of claim 13 characterized in that the aperture size of the lenticles (L) is a linear function of the distance of the lenticles from the central axis of the lenticular array.

15. Multi-lens lenticular array of claim 1 as an illumination device for an autostereoscopic display, comprising in the direction of propagation of the light an illumination matrix (7) with a plurality of matrix-like arranged, controllable openings (21) illuminated in transmission, or self-luminous light sources (21), and a focusing matrix (8), consisting of a lenticular array (LM) with a plurality of adjacent lenticles (L) each of which is aligned parallel to the columns or lines of the illumination matrix (7), whereby the matrix (8) of the light from said openings (21) is focused such that a subsequent transmissive information panel (5) and a selectable preferred region of visibility (6) are illuminated in the viewer plane (9) in a directed manner characterized in that the lenticles (L) of the lenticular array (3) each are divided into sublenticles (S1, S2, . . . ) and the sublenticles (S1, S2, . . . ) are arranged and aligned such that in the region of visibility (6) a nearly homogeneous luminance distribution results.

16. Multi-lens lenticular array for an illumination device for an autostereoscopic display of claim 15 characterized in that the sublenticles (S1, S2, . . . ) are arranged and aligned such that the light from an opening (21) in the region of visibility (6) leads to a multiplied number of images corresponding to the number of sublenticles (S1, S2, . . . ) which are created with the luminance distribution (V11 with A,A′ to V13 with C,C′) thereof, where the images are laterally shifted and overlapping, and a resulting broadened luminance distribution (V) in the region (A to C′) is created.

17. Multi-lens lenticular array as an illumination device for an autostereoscopic display of claim 16 characterized in that the sublenticles (S1, S2, . . . ) are arranged and aligned such that the images of laterally neighboring openings (21) originating from the same lenticle (L) each superimpose in the sloping marginal regions of said broadened luminance distributions (V) and thus in the region of visibility (6) a nearly homogeneous luminance distribution is created.

18. Multi-lens lenticular array as an illumination device for an autostereoscopic display of claim 17 characterized in that from the predetermined superimpositions of the luminance distribution (V) as well as by a defined geometry of the openings (21) the arrangement and alignment of the sublenticles (S1, S2, . . . ) is defined.

19. Illumination device for an autostereoscopic display of claim 15 characterized in that the focusing matrix (8) consists of a combination of several multi-lens lenticular arrays (LM).

20. Illumination device for an autostereoscopic display of claim 19 characterized in that one or several multi-lens lenticular arrays (LM) are combined with further optical means.
